(19) United States
(12) Patent Application Publication
(10) Pub. No.: US 2002/0108324 A1
(43) Pub. Date: Aug. 15, 2002

(54) Window panels

(75) Inventor: Lyman B. Maynard, Oakville (CA)

Correspondence Address: HAHN LOESER & PARKS, LLP, TWIN OAKS ESTATE, 1225 W. MARKET STREET, AKRON, OH, 44313, US

(73) Assignee: L&P Property Management Company

(21) Appl. No.: 10/027,245

(22) Filed: Dec. 20, 2001

Related U.S. Application Data
(63) Continuation of application No. 09/395,007, filed on Sep. 13, 1999, now abandoned.

(51) Int. Cl. E06B 3/28

(52) U.S. Cl. 52/203

(57) ABSTRACT

The present invention relates to the conversion of a vehicle to cover the windows, more specifically to a conversion using opaque panels permanently attached to selected windows of a vehicle. The flexible panels are formed and cut to match the exact dimensions of a window of a particular make and model vehicle. The panels are attached to the exterior of the windows using an appropriate adhesive. The panels prevent people from looking through the covered window. The panels may be painted to match the exterior paint of the vehicle. In addition, the panels provide an increased area for applying advertising to the side and rear of the vehicle.

The present invention relates to the conversion of a vehicle to cover the windows, more specifically to a conversion using opaque panels permanently attached to selected windows of a vehicle.

### BACKGROUND OF THE INVENTION

Cargo vans and like vehicles have been developed by vehicle manufacturers with the specific intention of providing individuals with the ability to transport large amounts of product, equipment, packages, etc. Such vehicles can provide a more practical and cost effective alternative to a larger truck. These vans are often made with no side windows or rear windows so that people can not view the contents of the vehicle from the outside. Further, storage racks or the like may be mounted on the interior walls of a cargo van without interfering with windows or destroying the aesthetic appearance. The removal of the windows also allows a larger area for the side and rear of the cargo van to be used as a “billboard” for advertising the company. These vehicles are desirable for many applications, and thus manufacturers have resorted to manufacturing these specialized vehicles as a counterpart to a passenger van vehicle using windows. Because the vehicles are specially manufactured to meet the niche market for such vehicles, it would be desirable to allow conversion of a standard passenger vehicle to a similar special use. Further, as cargo vans of this type are not as readily available as passenger vehicles, such as a minivan, allowing use a such a passenger vehicle for a specialized purpose would be advantageous. A passenger vehicle also will have a higher resale value when retired from the specialized use application, particularly if it can be converted back to a passenger vehicle.

Since the introduction of the minivan, the vehicle has become extremely popular with families for its versatility. The minivan can be used to carry either passengers or cargo by quickly converting to either use by inserting or removing the rear seats. Mini-vans have also attained great popularity for use by businesses to haul around light equipment, make deliveries, and other related uses which do not require the larger cargo van. A problem with such usage is that the minivan has windows on its side and rear which allow the contents of the vehicle to be seen by persons outside the vehicle. In addition, the windows impede the use of the sides and rear of the vehicle to be used as a billboard or location for graphic material to advertise a company name, service or other materials. Any use of graphic material is also generally not aesthetically pleasing. Although one original equipment manufacturer has produced a limited number of minivans where the side quarter panel windows are deleted, such vehicles are not generally available, or have even been discontinued due to the limited market. Alternatively, these types of vehicles may also require special ordering, and the cost is substantially higher. It would thus be desirable to allow conversion of a windowed vehicle produced by an original equipment manufacturer to be converted for use as a “cargo” type vehicle.

### SUMMARY OF THE INVENTION

It is therefore an object of the present invention to provide a conversion system and method for covering the existing windows of a vehicle in a manner preventing the contents of the vehicle to be seen from the outside of the vehicle.

It is also an object of the present invention to provide window covers for a vehicle which can be used to increase the space availability for advertising on the side or rear of the vehicle.

A further object of the invention is to provide a window cover for a vehicle which is rigid, and is adhered to a window in a manner to provide additional structural integrity to the window to impede access to the vehicle through the windows. Such additional structural integrity along with preventing visibility into the vehicle would impede the “smash-and-grab” thefts which may occur otherwise. The window cover according to the invention may also be constructed of a material which would inhibit scratching or the like to maintain an aesthetically pleasing appearance.

The invention disclosed and described herein provides a conversion system and method for covering the existing windows of a windowed vehicle, such as a window van. The window coverings are preferably constructed from a rigid material, and are opaque to prevent the contents of the vehicle from being seen from the outside of the vehicle. The covers in a preferred embodiment can be constructed of a thermoplastic material such as ABS plastic, and can be colored, coated or painted. The coverings provide an increase in area to allow the space on the vehicle side and/or rear to be used for graphical information, such as a large billboard to advertise the company name, goods and/or services provided as an example. The coverings are preferably manufactured of a thin polymer material which has the ability to conform to the curved surface of the glass window. The covering is preferably permanently affixed to the window using an adhesive applied to the face of the panel. In one embodiment, the adhesive is applied to the entire face of the panel, or alternatively, an adhesive could be applied or positioned at discrete locations on the face of the panel to adhere it to the window. It may be desirable under certain conditions to allow the egress of moisture which could be entrapped behind the panel once adhered to the window. The coverings may be designed to match the window size exactly, or could be trimmed if needed to match the window configuration.

These and other objects and advantages of the present invention will become apparent from a reading of the attached specification and appended claims.

### BRIEF DESCRIPTION OF THE DRAWINGS

FIGS. 1a and 1b are side and rear views of a vehicle, such as a mini-van.

FIGS. 2a and 2b are front and side views of a window cover panel according to a preferred embodiment of the present invention.

FIG. 3 is a front view of an alternative embodiment of the invention.

FIGS. 4a and 4b are side and rear views of the vehicle as shown in FIG. 1 with the window covers of the present invention installed thereon.

FIGS. 5a and 5b are side and rear views of the vehicle as shown in FIG. 1 with the window covers of the present invention installed thereon and showing the application of graphical information thereto.

### DESCRIPTION OF THE PREFERRED EMBODIMENT

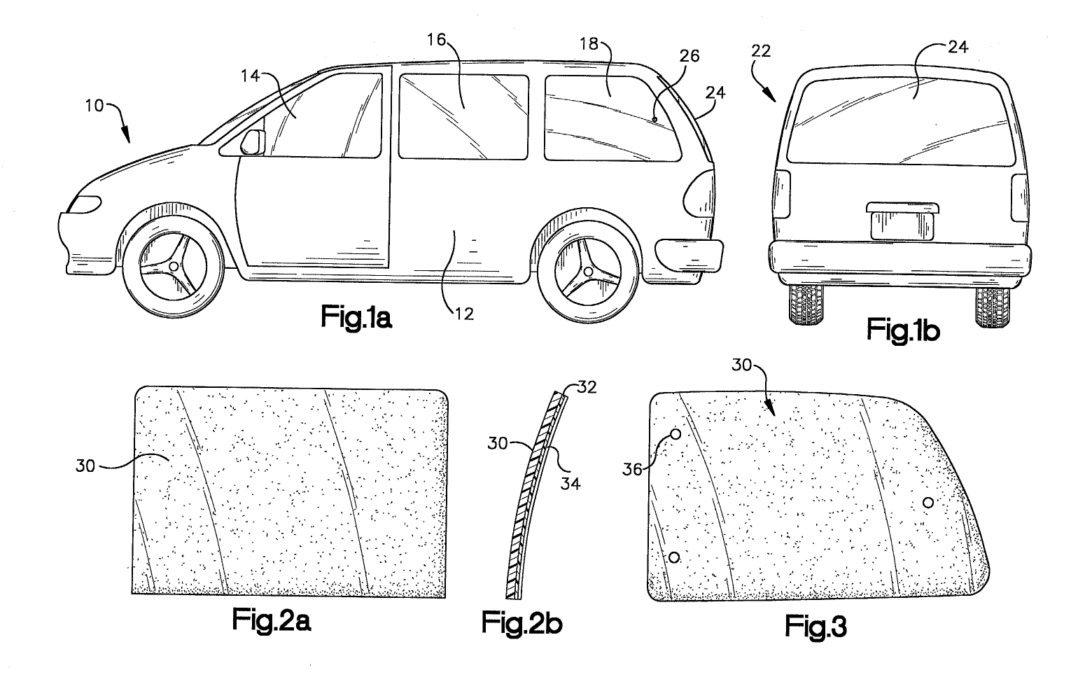

In the following detailed description of preferred embodiments of the present invention, reference is made to the accompanying drawings which, in conjunction with this detailed description, illustrate and describe a vehicle conversion system and method including a window cover panel in accordance with the present invention. Referring now to the drawings, in which like-referenced characters indicate corresponding elements throughout the several views, attention is first directed to FIG. 1, wherein a vehicle 10, such as a minivan, is shown. As seen in FIG. 1a, the vehicle comprises a side 12, front side window 14, middle side window 16, and rear side window 18. In FIG. 1b the vehicle rear 22, or trunk, is shown with rear window 24. Some vehicle windows are designed to open on a hinge (not shown). These hinges typically result in an exterior button 26 on the exterior window. The windows shown are all representative of the standard factory windows of a windowed vehicle, such as a minivan, station wagon, conversion van, passenger van, cargo van or the like.

Referring now to FIGS. 2a and 2b, a preferred embodiment of a window cover panel 30 according to the invention is shown. The panels 30 are preferably manufactured to match standard sizes which correspond to the various window sizes of a particular vehicle make and model. Panel 30 is preferably made of a rigid polymeric material such as acrylonitrile butadiene styrene (ABS), but other suitable materials are contemplated. Although preferably formed as a rigid panel, the panel 30 also desirably allows some flexing or shaping to conform to a window shape. Thus, panel 30 may be configured with a thickness or gauge which allows such bending or flexing, or could be formed of a material which allows this function. In practice, a panel 30 made of an ABS material having a thickness of approximately 0.050 to 0.15 inches has been found to function acceptably, but any thickness may be acceptable depending on the material from which it is constructed or other factors.

The panel 30 is also preferably rigid to enhance weatherability and provide an aesthetic appearance which emulates the appearance of the sides 12 or back 22 of the vehicle 10 adjacent the windows. The material may also be made scratch-resistant to maintain a desired appearance. The preferred rigid panel 30 also is found to facilitate providing additional structural integrity to the window on which is applied. The panel 30 helps to absorb any impacts on the window, and if such an impact is of a force to cause breakage of the window, the panel 30 tends to maintain the integrity of the window panel, with any pieces of the window tending to remain adhered to the panel 30. This will in turn impede the ability to gain access through the window of a vehicle which has been covered with panel 30.

Although the preferred cover panel 30 is formed of a rigid type of material, it could also be produced of a more resilient material. Some attributes of a harder material would not be realized in such an embodiment, but other features would be maintained. The panel 30 could also be produced as a laminate of two or more layers of material to provide desired structural or other characteristics. For example, a panel 30 could be formed with a flexible, resilient material on the interior thereof, which is applied to the window, and a hard outside layer or shell. Other such embodiments are also contemplated, to provide desired physical characteristics for a particular application. Again as examples, the panel 30 could be provided with an exterior surface particularly adapted to have graphical information applied thereto, or could be formed of materials which would enhance the structural integrity of the panel 30 for security purposes or the like, such as by use of materials having particular physical characteristics. Other desired attributes for a particular purpose or application would be apparent to one skilled in the art, and can be easily achieved using different combinations of materials and/or laminates as desired.

In the embodiment as shown in FIG. 2, the panels 30 are preferably manufactured by vacuum forming techniques, such that panels 30 can be made to conform to the compound curves which may be present in a standard vehicle window. The cross-section of FIG. 2b shows the curved panel, and any compound curve in a window can be accurately matched using these forming techniques. Providing panel 30 with curvatures to match the window facilitates application of the cover panel to a window, and will also facilitate forming a proper bond with the window upon being applied. Alternatively, the panels 30 may simply be stamped, molded or otherwise manufactured from a sheet of suitable material to substantially match or conform to the vehicle window to be covered. In such an embodiment, the panel 30 may be desirably constructed to allow it to conform to a window shape or curve. As yet another alternative, the panels 30 may be constructed to have dimensional characteristics to accommodate a variety of different window configurations, with the panel being trimmable or otherwise adapted to match a particular window.

The panels are preferably attached to the glass using an appropriate adhesive media 32 to permanently attach the panels 30 to the glass window. For safety purposes, the panels are desirably adhered to the glass in a manner so as to eliminate the possibility of the panel becoming loose and potentially being blown off the window during operation of the vehicle. It has been found that full face adhesion of the entire surface of panel 30 to a window provides this function, although providing an adhesive at discrete locations on the panel may be sufficient. The adhesive also preferably has adhesion characteristics to maintain proper adhesion of the panel 30 to a window under all operating conditions of a vehicle, including under differing temperature, moisture and like conditions. Thus, in alternate embodiments, the adhesive layer 32 is applied to the entire face of the panel 30, or is positioned at discrete locations on the panel to properly adhere it to the window. Also in the preferred embodiment, the layer of adhesive is applied to the panel, and a further release paper layer 34 may be used to protect the adhesive layer until use of the panel 30 is desired, similar to adhesive labels or the like. In practice, it has been found that a double-sided adhesive film, such as produced by 3M company under product number F-9473PC may be suitable in conjunction with an ABS panel, but other suitable adhesives are contemplated. As an example, a foam adhesive in strips or other configurations may be applied at discrete locations on the panel. The adhesive material may be applied to the panel 30 when use is desired, such as an adhesive strip, a liquid adhesive or the like, positioned or spread over at least a portion of the surface. Again, in the preferred embodiment, the adhesion characteristics will prevent possible release of the panel 30 during operation of the vehicle 10. It may also be desirable to adhere the panel 30 at least at the edges thereof to inhibit the ingress of air or moisture between the panel 30 and the vehicle window. Although these attributes are contemplated in the preferred embodiments, other suitable arrangements for properly securing the panel 30 to the vehicle window are also contemplated. The adhesive media 32 is preferably a double-sided adhesive film applied to the mating surface of panels 30 with a roller press, taking advantage of the flexibility of the panels 30. The adhesive can be applied during manufacture by laminating the film layer to the panel from roll stock or the like.

For use, the paper backing layer is removed just prior to attachment of the panel 30 onto the window. The media 32 is applied to the entire mating surface 34 of the panels 30. The window is generally cleaned of any debris or contamination prior to attachment of the panel 30, and the panel 30 is pressed into position in a manner to prevent trapping of air between the panel 30 and the window.

As shown in FIG. 3, the panels 30 may also be designed to cover any exterior buttons 26 without inhibiting the direct contact of the panel to the window surface. The panel 30 itself may be formed with a hole 36 to match the location of the buttons 26 or formed with a button accommodating portion at these locations, which would be easily accomplished in a formed panel, such as a vacuum formed or molded panel embodiment.

The panels 30 are preferably colored, coated or painted to yield the desired appearance, such as to match the vehicles color using the factory paint code. The color can also be applied to the panels by the use of body colored decal material. When in hotter climates, especially when using darker colors, the window cover panels are preferably made of a more suitable material such as a high temperature fiberglass ABS material which will effectively prevent degradation of the panels in higher temperature environments. Although the panels may be opaque, some light transmission through the panel 30 may be desirable, and can be accommodated by suitable choice of materials or coloration. As an example, the panel 30 may be covered with a one-way mirrored type of material or other composite or laminate material that allows a level of light to be transmitted therethrough. Such materials may give the appearance of being solid but allow some light transmission.

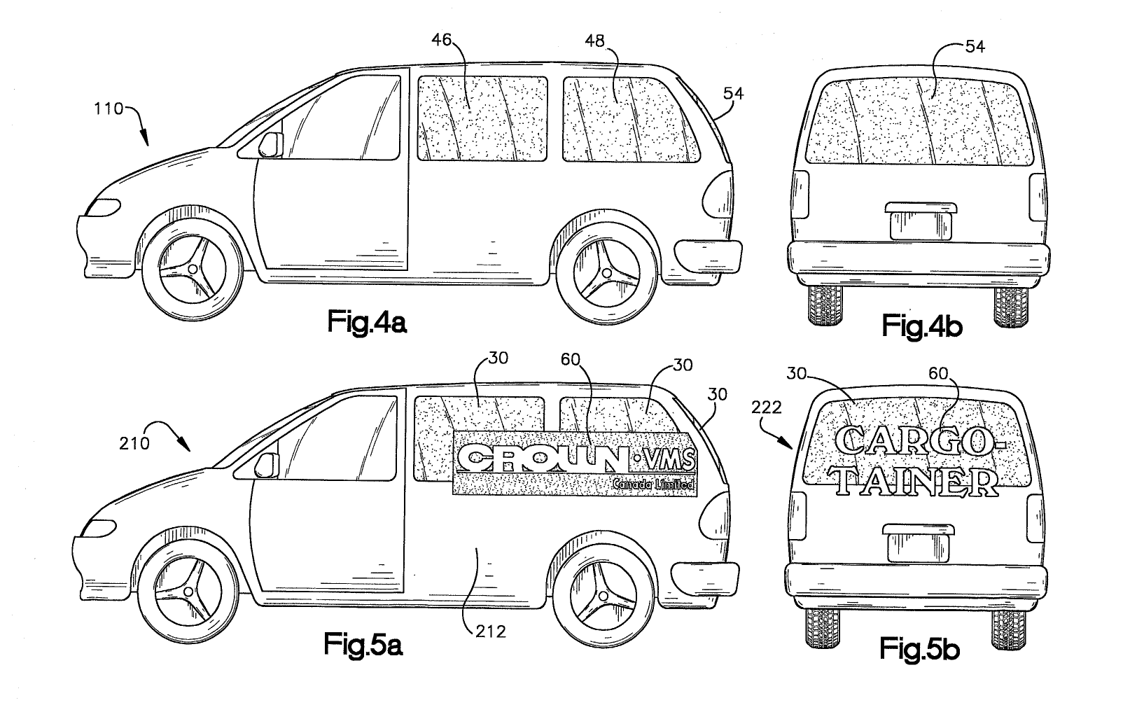

The panels 30 are positioned directly over the corresponding window and attachably pressed into position. As shown in FIG. 4, a modified vehicle 110 includes window cover panels 46, 48, and 54 covering the middle side window 16, rear side window 18 and rear window 24, respectively. The window cover panels 30 prevent persons from looking into the vehicle 110 through these covered windows. The panels 30 also protect the interior of the vehicle 110 from direct sunlight. The panels 30 transform the vehicle 110 into a cargo/panel vehicle in that the panels do not inhibit the aesthetic qualities of the vehicle.

As shown in FIG. 5, the panels 30 increase the availability of space available for advertising on the side 212 and rear 222 of the vehicle 210. Decals 60, or another coating or paint can be added to the exterior of the vehicle, including the panels 30, to advertise on this larger area.

Although the present invention has been described above in detail, the same is by way of illustration and example only and is not to be taken as a limitation on the present invention. Accordingly, the scope and content of the present invention are to be defined only by the terms of the appended claims.

What is claimed is:

1. A cover for the window of a vehicle comprising:
a panel having an exterior surface and an attachment surface, said panel being configured to substantially match the shape of a window to be covered;
an adhesive media covering at least a portion of said attachment surface;
wherein said attachment surface of said panel is attached to a surface of said window in a manner to completely cover said window such that only said exterior surface is exposed.

2. The cover according to claim 1, wherein said adhesive media covers the entire attachment surface of said panel.

3. The cover according to claim 1, wherein at least said exterior surface of said panel is colored to match an exterior color of said vehicle.

4. The cover according to claim 1, wherein said exterior surface of said panel is covered over at least a portion thereof with graphical material.

5. The cover according to claim 4, wherein said graphical material is provided on a decal attached to said exterior surface.

6. The cover according to claim 1, wherein said adhesive media is double sided adhesive film.

7. The cover according to claim 1, wherein said panel is formed with compound curves therein to substantially match the curves of the window to which it is to be applied.

8. The cover according to claim 1, wherein said panel is formed with at least one hole positioned to correspond to a protuberance on the window to which said panel is to be applied to accommodate said protuberance.

9. The cover according to claim 1, wherein the outside shape of said panel is formed to substantially match the shape of window to which it is to be applied.

10. The cover according to claim 1, wherein said panel is formed of a rigid material.

11. The cover according to claim 1, wherein said panel has a thickness to allow bending thereof to conform to the shape of a window on which it is to be applied.

12. The cover according to claim 1, wherein said panel is opaque.

13. The cover according to claim 1, wherein said panel has a thickness to impart structural integrity to said window to which it is attached.

14. The cover according to claim 1, wherein said panel has a thickness between about 0.050 to about 0.15 inches.

15. The cover according to claim 1, wherein said panel is formed as a laminate of at least two layers of material.

16. A method of covering a window of a vehicle comprising the steps of:
1) providing a panel having an outside shape formed to substantially match the shape of said window, said panel having an attachment surface and an exterior surface;
2) providing an adhesive over at least a portion of said attachment surface, and
3) attaching said panel to an exterior surface of said vehicle window.

17. The method according to claim 16, wherein said panel is vacuum formed with compound curves therein.

18. The method according to claim 16, wherein said adhesive is applied over the entire attachment surface.
